(19) United States
(12) Patent Application Publication
(10) Pub. No.: US 2022/0155223 A1
(43) Pub. Date: May 19, 2022

(54) LASER GAS ANALYSIS DEVICE

(71) Applicant: KYOTO ELECTRONICS MANUFACTURING CO., LTD., Kyoto-shi, Kyoto (JP)

(72) Inventors: Hajime ARIMOTO, Kyoto (JP); Hisataka MUKAI, Kyoto (JP); Shinji KAWASHIMA, Kyoto (JP)

(73) Assignee: KYOTO ELECTRONICS MANUFACTURING CO., LTD., Kyoto-shi, Kyoto (JP)

(21) Appl. No.: 17/598,547

(22) PCT Filed: Mar. 24, 2020
(86) PCT No.: PCT/JP2020/012822

§ 371 Date: Sep. 27, 2021

(30) Foreign Application Priority Data
Mar. 28, 2019 (JP) 2019-063002

(51) Int. Cl. G01N 21/3504; G01N 21/39

(52) U.S. Cl. CPC G01N 21/3504; G01N 2021/399; G01N 21/39

(57) ABSTRACT

This laser gas analysis device compensates distortion of a laser beam and can place a detector depending on the wavelength used. A transmitter side process window unit consists of two wedge-shaped glass substrates that are positioned to have a space with an appropriate length along a laser propagation direction, and sends the laser beam from a transmitter unit to a measuring space. A receiver side process window unit is configured the same as the transmitter side process window unit, and sends the laser beam passed through the measuring space to a receiver unit. The outer surfaces of the two wedge-shaped glass substrates with respect to the space in between are placed to be parallel each other, and accordingly the inner surfaces are also parallel each other. The distance between the two wedge-shaped glass substrates in the laser propagation direction is determined so as to avoid optical interferences of the laser.

### TECHNICAL FIELD

This invention relates to a laser gas analysis device which utilizes a semiconductor tunable laser.

### BACKGROUND ART

A typical configuration of the laser gas analysis device for measuring a concentration of a gas species of interest in a process flue (measuring space) is shown in FIG. 4. The extractive overview of the optical configuration and the electrical functions of the device is schematically illustrated in FIG. 5. Similar diagrams can be seen, for example, in the invention disclosed in U.S. Pat. No. 9,224,003.

A beam emitted by a tunable laser in a transmitter unit 100 propagates through a transmitter side process window 110, a measuring space 30 and a receiver side process window 210, then finally is detected by a receiver unit 200. The transmitter side process window 110 spatially separates the transmitter unit 100 from the measuring space 30, and the receiver side process window 210 spatially separates the receiver unit 200 from the measuring space 30.

As illustrated in FIG. 5, the injection current provided by a laser driver 133 to the tunable laser element 111 is modulated in a frequency ranges from several tens to hundreds Hz by a sawtooth waveform generator 131, and the current is also sinusoidally modulated in the ranges from several tens to hundred kHz by a sinusoid waveform generator 132. As a result, the emission wavelength of the tunable laser element 111 can be modulated in the vicinity of the isolated optical absorption line of the gas species of interest. The light emission by the tunable laser element 111 is designed to be parallel beam by collimation optics 112 and is sent to the measuring space 30 through the transmitter side process window 110.

Then the transmitted beam of the modulated laser light passes through the measuring space 30 and the receiver side process window 210 to the receiver unit 200. The condensed laser light by collection optics 212 is injected to the photodetector 211 and is converted to the electric signal and the signal is synchronously detected by a lock-in amplifier 231.

The obtained waveforms show the features of the target gas species' optical absorption depending on its volume concentration.

For tunable lasers used here, the emission line width is typically in the order of several MHz, and the corresponding coherence length is in the ranges from several tens to hundreds m (meters). Accordingly, it is preferable to design to suppress the optical interference fringes or the optical noise due to the etalon effect for the measurement in the optical path length shorter than the laser coherence length described above. In fact, process flues have the optical path length from 1 to 10 m in general.

Therefore, as the transmitter side and the receiver side process windows (110 and 210) which separate the transmitter and the receiver units (100 and 200) from the measuring space 30, a wedge-shaped glass substrate is often employed instead of a flat parallel glass substrate. The optical interference and the optical noise are suppressed by the use of a wedge-shaped glass substrate because the distances between both sides of a wedge-shaped glass substrate or between wedge-shaped glass substrate surfaces and the other reflective surfaces are spatially varied continuously so that the interference conditions can be avoided.

The laser gas analysis device described above generally employs the collimation optics 112 placed in the adequate position after the laser emission point and the collection optics 212 placed in the adequate position before the photodetector in order to perform the spatially averaged measurement and to keep the transmitted optical power from the transmitter side to the receiver side as high as possible.

### CITATION LIST

### Patent Literature

Patent Literature 1: U.S. Pat. No. 9,244,003

### SUMMARY OF INVENTION

### Technical Problem

As described above, in order to separate the transmitter and the receiver units (100 and 200) from the measuring space 30, each wedge-shaped glass substrate is employed for the transmitter and the receiver sides, in general. Though the rays of the laser are parallelized by the collimation optics 112, they have spatially different diffraction angle after passing through the transmitter side process window 110. As a result, it is inevitable for the parallelized laser beam travelling through the measuring space to be distorted and to have some displacement from the geometrical optical axis. These distortion and displacement may be uncontrollable if the accuracy of the wedge-shaped glass substrate positioning is poor.

FIG. 6 shows an example of the distortion and the displacement described above. The distance between the transmitter side process window 110 and the receiver side process window 210 (the optical path length of measuring space 30) is approximately 1 m and the emission wavelength of the laser is 760 nm. At the plane where the collection optics 212 are positioned, the displacement Δα is approximately 1 cm from the geometrical optical axis α.

To make things worse, the following adverse effects occurs. Since the beam of a laser passed through the receiver side wedge-shaped glass substrate (the receiver side process window 210) enters the collection optics 212 with a deviated incident angle from the normal against the collection optics 212, the actual focal point is deviated from the intended focal point where the photodetector 211 placed. The photodetector 211 should be designed to be placed at the position deviated from the optically defined focal point, sacrificing the power of the laser.

In view of the above-mentioned problems in the actual use of conventional arts, the present invention provides with a laser gas analysis device which suppresses the beam deviation and can determine the photodetector position corresponding to the emission wavelength of the laser used.

### Solution to Problem

The present invention relates to a laser gas analysis device consists of a transmitter unit which sends a parallelized laser beam to a measuring space, a receiver unit which detects a laser beam passed through a measuring space, and in addition to these, a transmitter side process window unit and a receiver side process window unit described below.

The transmitter side process window unit is formed by two wedge-shaped glass substrates placed in a laser propagation direction in forming a specific space, and transmits the parallelized laser beam from the transmitter unit to the measuring space. The receiver side process window unit is configured as well as the transmitter side process window unit and transmits the laser beam passed through the measuring space to the receiver unit.

The two wedge-shaped glass substrates, which forms the specific space, includes a set of parallel outer surfaces facing the outside of the space in the beam propagation direction, and another set of parallel inner surfaces facing the inside. The distance of the two wedge-shaped glass substrates along the beam propagation direction shall be determined to reduce the optical interference.

The configuration of the gas analysis device disclosed in the present invention allows to introduce the gas mixture containing the gas species of interest into at least one of the spaces formed by the two wedge-shaped glass substrates in the transmitter side window unit or the receiver side window unit to check the device sensitivity and to perform the adjustment.

### Advantageous Effects of Invention

Under the configuration described above, the displacement from the geometrical optical axis is compensated regardless of the wavelength used. The overall optical axis for the visible wavelength laser and those for the near-infrared or mid-infrared lasers are identical. Therefore, it is advantageous that the optical alignment procedures are simple and easy, and the adjusted optical alignment of the device is stable. It is also advantageous that, owing to the normal incidence to the collection optics, the photodetector position is identical to the focal point of the collection optics depending only on the wavelength used. It is not necessary to adjust the photodetector position at and after installation, and the power of laser is not ruined.

Furthermore, it is advantageous that checking of the device sensitivity without removing the device from the installation flanges can be performed during the stop period of the measuring process, when there are no gas species of interest in the measuring space, by introducing the gas mixture containing the gas species of interest with known concentration into at least one of the spaces formed by the two wedge-shaped glass substrates in the transmitter side window unit or the receiver side window unit.

### BRIEF DESCRIPTION OF DRAWINGS

FIG. 1 is a diagram illustrating a basic principle in accordance with the present invention;

FIG. 2 is a diagram showing an optical path of a laser gas analysis device in accordance with the present invention;

FIG. 3 is a diagram showing the laser gas analysis device applying the present invention;

FIG. 4 is a diagram showing a conventional laser gas analysis device;

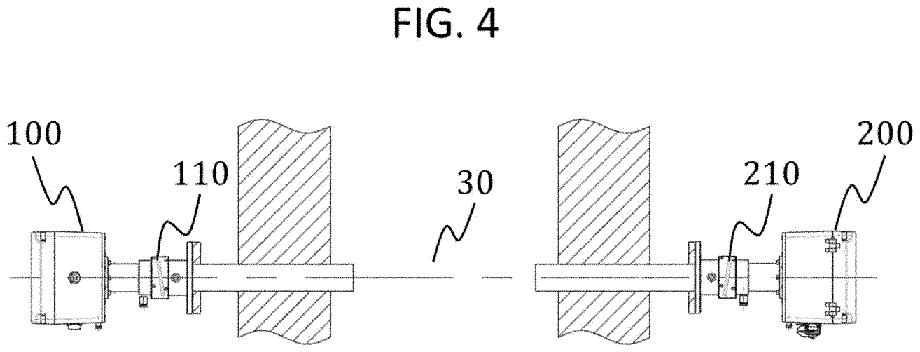

FIG. 5 is a diagram showing a functional overview of a laser gas analysis device; and

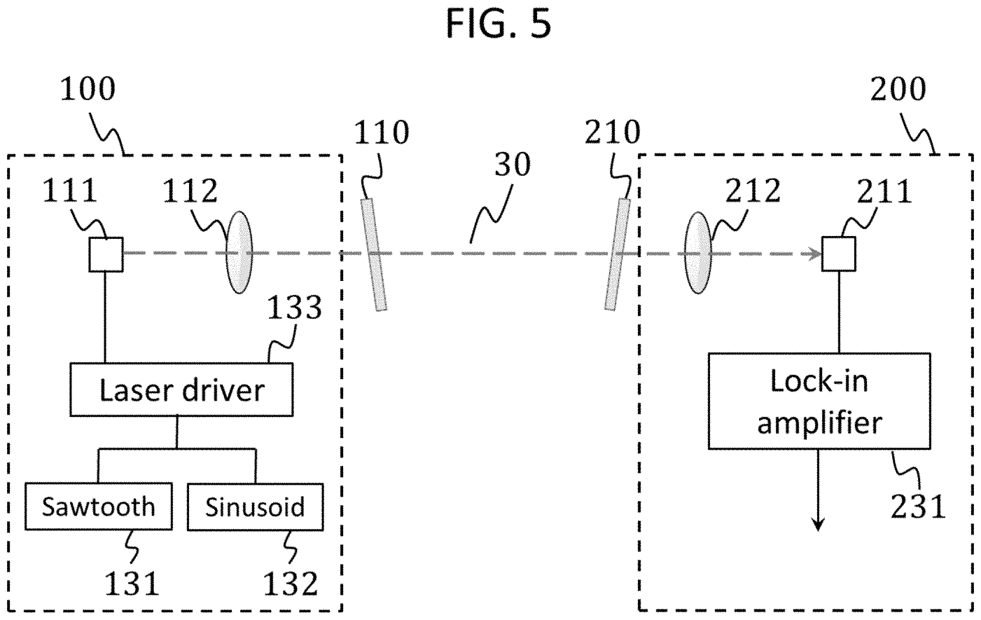

FIG. 6 shows an optical path of a conventional laser gas analysis device.

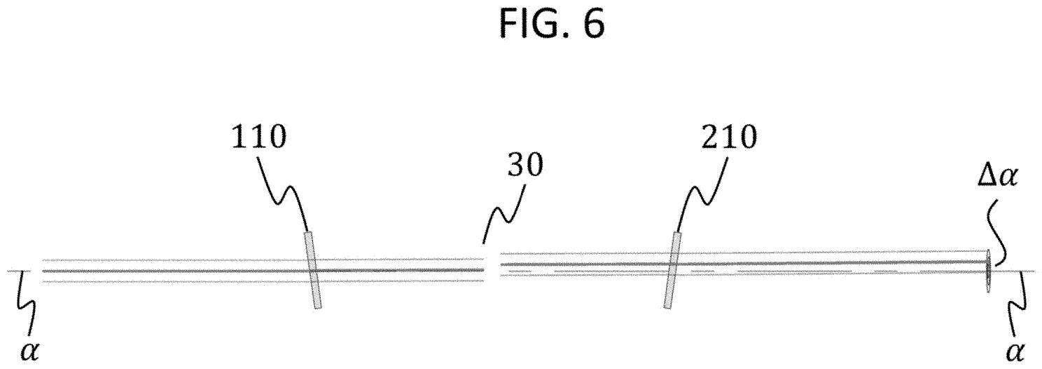

### DESCRIPTION OF THE EMBODIMENT

<Principle>

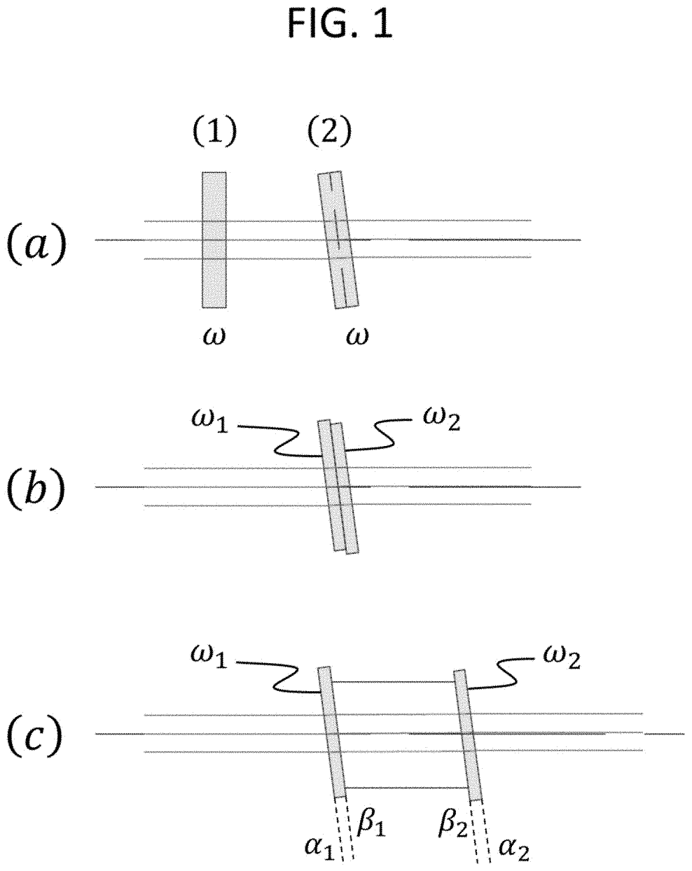

FIG. 1 is a diagram that illustrates a basic principle of the present invention.

A parallel beam normally injected to a flat parallel glass substrate ω is transmitted to a normal direction with no diffraction, i.e., the transmitted beam is parallel and is on the same geometrical optical axis as the incident beam as shown in FIG. 1 (a) (1). When the flat parallel glass substrate ω is tilted with respect to the geometrical optical axis, the parallel beam is likewise transmitted as the parallel beam, while a small displacement from the geometrical optical axis occurs due to refraction depending on the tilt angle and the refractive index of the flat parallel glass substrate as shown in FIG. 1 (a) (2). This indicates that, even if the flat parallel glass substrate is divided at a given angle (the dashed line in FIG. 1 (a) (2), for example) into two wedge-shaped substrates ω₁ and 107 ₂, the beam transmitted through two wedge-shaped substrates ω₁ and ω₂ is kept parallel as shown in FIG. 1 (b).

Furthermore, even though a space with a certain length is formed by the wedge-shaped glass substrate ω₁ and ω₂ toward a propagation direction, the beam transmitted through two wedge-shaped glass substrates ω₁ and ω₂ is consequently parallel to the incident beam and the displacement from the geometrical optical axis is also small as shown in FIG. 1 (c). That is, a distortion of the transmitted beam occurred against the injected parallel beam at the upstream side wedge-shaped glass substrate ω₁ is compensated by the downstream side wedge-shaped glass substrate ω₂ and the resultant beam transmitted two wedge-shaped glass substrates ω₁ and ω₂ is kept parallel.

The two wedge-shaped substrates ω₁ and ω₂ which form a space with a certain length along the propagation direction have two sets of the parallel surfaces. The outer surfaces α₁ and α₂ with respect to the space in between are placed to be parallel each other. Accordingly, the inner surfaces β₁ and β₂ with respect to the space in between are also parallel each other.

In the present invention, the transmitter side process window unit and the receiver side process window unit described hereafter are configured utilizing the above-mentioned two wedge-shaped substrates ω₁ and ω₂ placed with the specific space in between.

The length of the space along the laser propagation direction is determined so that the distortion occurred when passing through the upstream side wedge-shaped substrate ω₁ to be effectively compensated by the downstream side wedge-shaped substrate ω₂ as described above. The length of the space is also determined by taking the optical interference of the laser into account.

<Configuration>

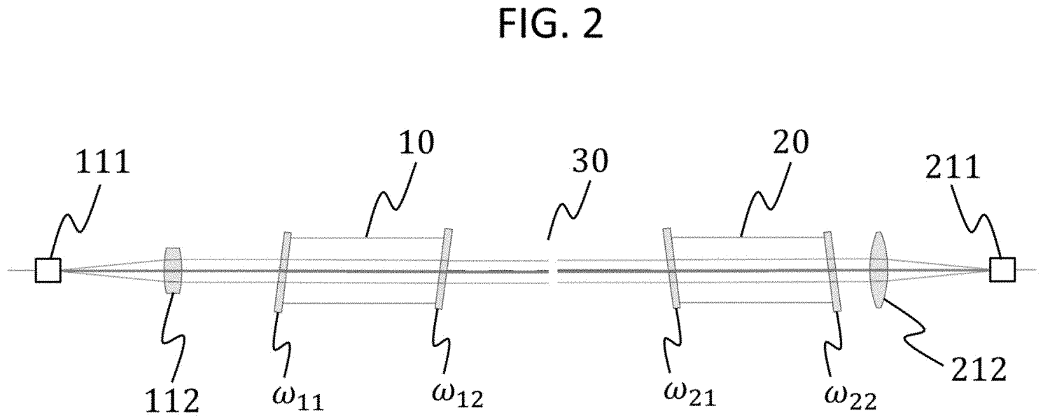

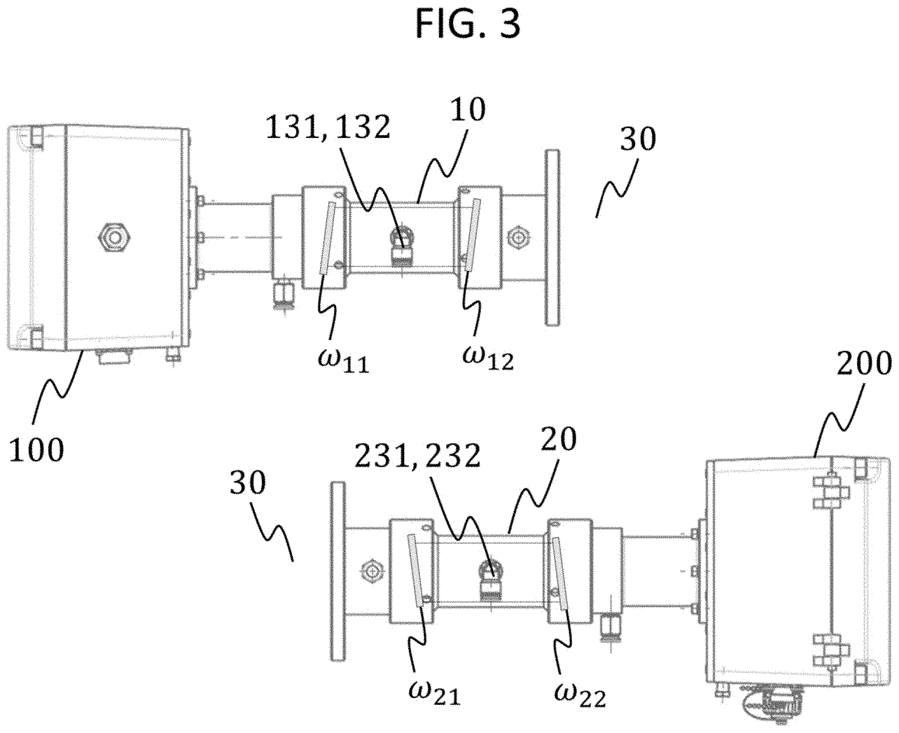

FIG. 2 shows the example of an optical path of the laser gas analysis device in accordance with the present invention. FIG. 3 illustrates details of the laser gas analysis device in accordance with the present invention. The configuration is essentially the same as conventional arts wherein a transmitter unit 100 and a receiver unit 200 are installed at the opposite side of a process flue (a measuring space 30).

The light emission by the tunable laser element 111 in the transmitter unit 100 is parallelized by the collimation optics 112, and then transmits through the transmitter side process window unit 10. The transmitter side process window unit 10 consists of two wedge-shaped glass substrates ω₁₁ and ω₁₂ forming a space in between with an appropriate length as described above. The wedge-shaped glass substrate ω₁₂ is the process window which separates the transmitter unit 100 and the transmitter side process window unit 10 from the measuring space 30.

The parallel beam passed through the transmitter side process window unit 10 propagates through the measuring space 30, and then enters the receiver side process window unit 20. The receiver side process window unit 20 consists of two wedge-shaped glass substrates ω₂₁ and ω₂₂ forming a space in between with an appropriate length. The wedge-shaped glass substrate ω₂₁ is the process window.

The parallel beam transmitted through the receiver side process window unit 20 is injected to the collection optics 212 and falls on the photodetector 211.

In the laser gas analysis device configured as described above, the distortion of the beam occurred in the light passed through the upstream side wedge-shaped glass substrate ω₁₁ is compensated by the downstream side wedge-shaped glass substrate ω₁₂. Consequently, the parallel beam injected into the transmitter side process window unit 10 is transmitted as the parallel beam and enters the measuring space 30.

Then the parallel beam transmitted through measuring space 30 is injected to the receiver side process window unit 20. The distortion of the beam occurred again in the light beam passed through the upstream side wedge-shaped glass substrate ω₂₁ is compensated by the downstream side wedge-shaped glass substrate ω₂₂. As a result, the light beam parallelized by the collimation optics 112 in the transmitter unit and the beam injected into the collection optics 212 in the receiver unit is centered on the same geometrically defined optical axis.

By adopting the above configuration, the light beam is kept parallel, and the optical axis is identical regardless of the wavelength used whatever in visible, near-infrared or mid-infrared. According to this, the optical alignment procedures are simple and easy, and the adjusted optical alignment of the device is stable. Moreover, the normal incidence of the beam to the collection optics enables to design to place the photodetector at the focal point of the collection optics depending only on the wavelength used, and the power of the laser is not ruined.

In the above embodiment, the transmitter unit 100 and the transmitter side process window unit 10, and the receiver unit 200 and the receiver side process window unit 20 may be configured as one unit, respectively, otherwise may be separately configured. In case of separated units, it is possible to remove the transmitter unit 100 and the receiver unit 200 leaving the transmitter side process window unit 10 and the receiver side process window unit 20 at the installation flanges and to perform the maintenances of the transmitter unit 100 and the receiver unit 200 when necessary, even when the process is working.

In FIG. 3, also shown are tube fittings 131, 132 (231, 232) for respective an inlet and an outlet of the transmitter side (the receiver side) process window unit 10 (20) to introduce the gas mixture containing the gas species of interest with known concentration into the space formed by the two wedge-shaped glass substrates. Though the reference numerals 131 and 132 (231 and 232), the tube fittings, indicates the same object on the figure, the front side of the page is the inlet, and the back is the outlet, for example.

Owing to the above configuration, when the gas mixture containing the gas species of interest with known concentration is introduced into the space formed by two wedge-shaped glass substrates during the stop period of the measuring process, the checking of the device sensitivity or the scale adjustment without removing the device from the installation flanges can be performed according to the output signal of the lock-in amplifier. That is, the space can be utilized as a reference gas flow cell.

### INDUSTRIAL APPLICABILITY

As mentioned so far, the optical alignment procedures of the device are to be simple and easy, and the adjusted optical alignment of the device is stable, compensating the distortions and displacements of the beam regardless of the wavelength used. It is not necessary to adjust the photodetector position at installation or maintenance. The maintenance work can be performed even when the measuring process is in operation. The checking of the sensitivity can be performed without removing the device from the process during the stop period of the measuring process. Therefore, the device in the present invention is quite beneficial for the practical applications.

### REFERENCE SIGNS LIST

10 transmitter side process window unit

20 receiver side process window unit

30 process flue (measuring space)

100 transmitter unit

110 transmitter side process window

111 tunable laser element

112 collimation optics

210 receiver side process window

211 photodetector

ωflat parallel glass substrate

ω₁, ω₂, ω₁₁, ω₁₂, ω₂₁, ω₂₂ wedge-shaped glass substrate

α₁, α₂ outer surface of two wedge-shaped glass substrates

β₁, β₂ inner surface of two wedge-shaped glass substrates

1. A laser gas analysis device including a transmitter unit sending a light emission from a tunable laser to a measuring space and a receiver unit detecting the laser transmitted through the measuring space, comprising:
a transmitter side process window unit formed by two wedge-shaped glass substrates placed in a laser propagation direction in forming a specific space, and transmitting the laser beam from the transmitter unit to the measuring space; and
a receiver side process window unit formed as well as the transmitter side process window unit, and transmitting the laser beam passed through the measuring space to the receiver unit.

2. The laser gas analysis device according to claim 1, wherein
the two wedge-shaped substrates forming the prescribed space have outer surfaces of the two wedge-shaped glass substrates with respect to the specific space in between are placed to be parallel each other, and inner surfaces are also parallel each other.

3. The laser gas analysis device according to claim 1, further comprising:
a unit for streaming or filling the space in the window units with a measuring gas species, and checking and adjusting the sensitivity.
